(19) United States
(12) Patent Application Publication
(10) Pub. No.: US 2006/0187666 A1
(43) Pub. Date: Aug. 24, 2006

(54) Vehicle lamp

(76) Inventor: Horst Deichmuller, Eisenach (DE)

Correspondence Address: THE BILICKI LAW FIRM, PC, 1285 North Main Street, JAMESTOWN, NY, 14701, US

(21) Appl. No.: 11/355,127

(22) Filed: Feb. 14, 2006

(30) Foreign Application Priority Data
Feb. 15, 2005 (DE) 102005006824.3

(51) Int. Cl. B60Q 1/076

(52) U.S. Cl. 362/459

(57) ABSTRACT

A vehicle lamp includes a lamp housing which can be introduced into a bodywork opening until an abutment provided thereon comes to bear against a part of the vehicle. A sealing means in the installed condition sealingly closes the bodywork opening. At least one latching means engages behind the edge of the bodywork opening to prevent the vehicle lamp from moving out of the bodywork opening. To reduce the tolerance requirements the lamp housing comprises first and second housing portions of which the first has the abutment and the latching means and the second has the sealing means. The housing portions are displaceable relative to each other in the installation direction from a pre-assembly position into a final assembly position. A bistable spring arrangement mounted on them urges the housing portions in the pre-assembly position away from each other in opposite relationship to the installation direction and in the final assembly position pulls them towards each other in the installation direction in such a way that the sealing means is pressed from the exterior against the outside surface of the bodywork.

### CROSS-REFERENCE TO RELATED APPLICATION

This application claims the priority of German patent application Serial No. 10 2005 006 824.3 filed Feb. 15, 2005.

### FIELD OF THE INVENTION

The invention concerns a vehicle lamp.

### SUMMARY

There is provided a vehicle lamp including a lamp housing which can be introduced from the exterior into a bodywork opening until an abutment provided thereon comes to bear against a part of the vehicle, and a sealing means for sealingly closing the bodywork opening. At least one latching means for engaging behind the edge of the bodywork opening to prevent the vehicle lamp from moving out of the bodywork opening. The lamp housing further comprises first and second housing portions. The first housing portion includes the abutment and the at least one latching means, while the sealing means is provided on the second housing portion. The two housing portions are so mounted to each other that they are displaceable relative to each other in the installation direction from a pre-assembly position into a final assembly position. A bistable spring arrangement is mounted on the housing portions in such a way that in the pre-assembly position it urges the housing portions away from each other in opposite relationship to the installation direction and in the final assembly position it pulls them towards each other in the installation direction in such a way that the sealing means is pressed from the exterior against the outside surface of the bodywork.

As will be apparent from the description of the embodiments, the first and second housing portions, which are displaceable relative to each other in the insertion direction, are provided for supporting and providing latching engagement in the region surrounding the opening in the bodywork as well as for sealing closure of the opening in the bodywork. The first housing portion has an abutment which prevents the vehicle lamp from being inserted into the bodywork opening to an excessive depth in the assembly operation. Also provided on the first housing portion are the latching devices which engage behind the edge of the bodywork opening, when the vehicle lamp is completely inserted. The spacing thereof from the surface of the abutment, which comes to bear against the outside of the bodywork, is completely non-critical as the abutment as such does not perform any sealing functions.

Rather, a sealing function is associated with the second housing portion, which is urged outwardly in opposite relationship to the insertion direction with respect to the first housing portion by the bistable spring arrangement. When the vehicle lamp is introduced into the bodywork opening to such an extent that the abutment of the first housing portion comes to bear against the outside of the bodywork, the application of a further force acting in the insertion direction, against the second housing portion, means that the latter can be displaced in relation to the first housing portion until the bistable spring arrangement moves beyond its dead point. The spring arrangement then exerts a force which biases the second housing portion in the insertion direction relative to the first housing portion. Therefore, the first housing portion is pressed with its latching devices against the inside of the bodywork while at the same time the second housing portion is pressed with its sealing arrangement against the outside of the bodywork. In a final assembled condition, there is no longer any need for the abutment of the first housing portion to bear against the outside of the bodywork as the sealing function is performed entirely by the sealing arrangement of the second housing portion.

The above-described spring action in the installation direction thus permits advantageous tolerance compensation and allows relatively large manufacturing tolerances for the functional elements which serve for fixing purposes.

The pressing force of the sealing arrangement can be varied within wide limits according to the respective requirements involved, by making the spring force of a suitable magnitude.

### BRIEF DESCRIPTION OF THE DRAWINGS

FIG. 1 is a cross-sectional view of a vehicle lamp in a pre-assembly condition taken along line I-I of FIG. 5.

FIG. 2 is a cross-sectional view corresponding to FIG. 1, showing the vehicle lamp of FIG. 1 in a finished assembled condition,

FIG. 3 shows a cross-sectional view of the vehicle lamp in a pre-assembly condition taken along section line III-III in FIG. 5,

FIG. 4 is a cross-sectional view corresponding to FIG. 3 of the vehicle lamp in the finished assembled condition, and

FIG. 5 is a diagrammatic rear view of the vehicle lamp of FIGS. 1 to 4.

### DESCRIPTION OF THE PREFERRED EMBODIMENT

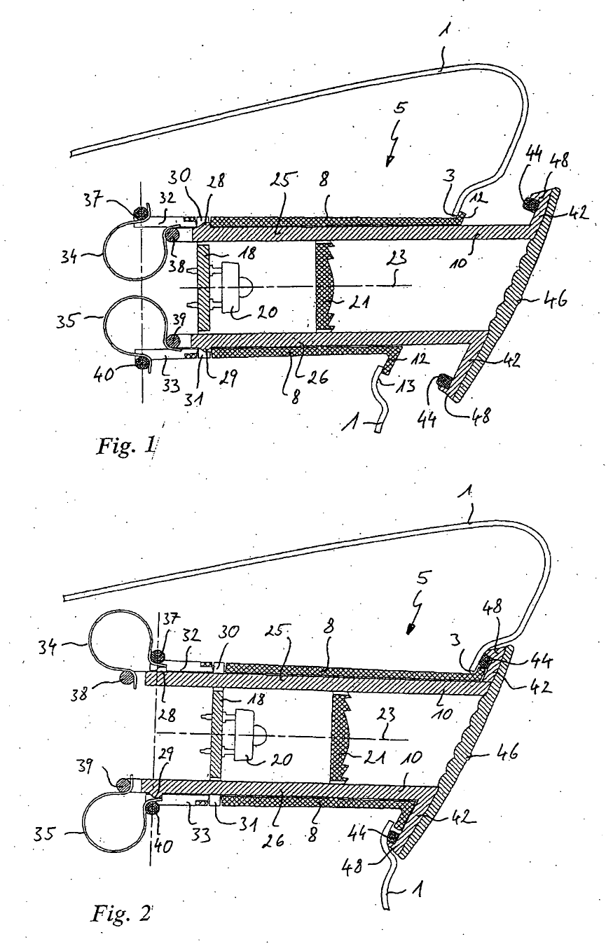

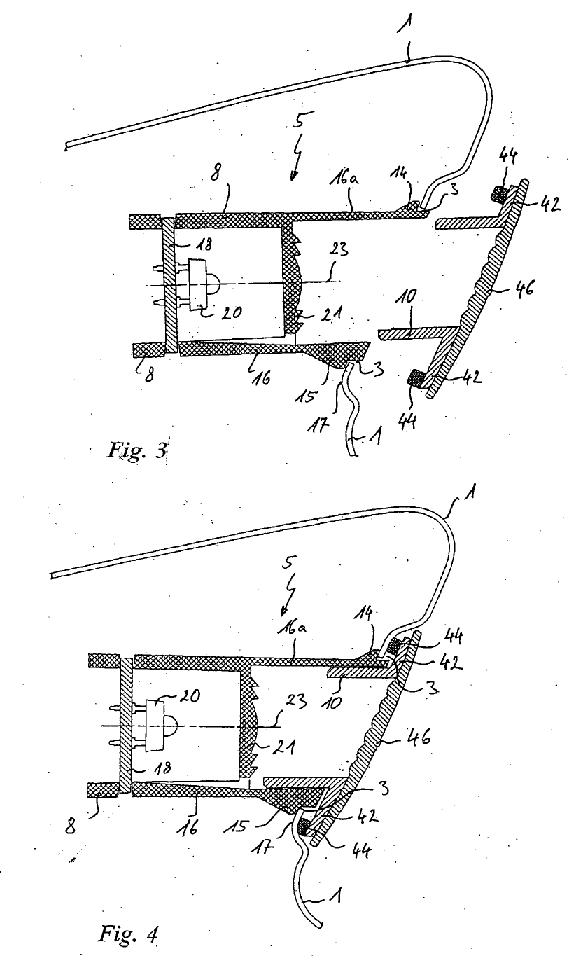

Referring to FIGS. 1 through 4, a part of a body 1 of a vehicle with a bodywork opening 3 into which a vehicle lamp 5 inserted from the front, is shown, in a pre-assembly condition in FIGS. 1 and 3 and in a definitively assembled condition in FIGS. 2 and 4.

As can be seen from FIGS. 1-4, vehicle lamp 5 has a lamp housing comprising two housing portions 8 and 10 which are displaceable relative to each other in parallel relationship with the insertion direction, i.e. from right to left or left to right.

First housing portion 8 has an abutment indicated at 12 in FIG. 1 which projects transversely with respect to the insertion direction in the form of a peripherally extending, partially interrupted flange or collar in order to limit the insertion depth of first housing portion 8 into bodywork opening 3 by virtue of abutment 12 coming to bear against an outside surface 13 of the bodywork in the region surrounding bodywork opening 3.

Alternatively abutment 12 of first housing portion 8 can be designed such that it comes to bear against another fixed part of the vehicle, within the bodywork.

In one embodiment, first housing portion 8 is substantially in the form of a hollow body which is open at its two ends.

As can be seen in particular from FIGS. 3 and 4 first housing portion 8, has latching noses 14 and 15 which have inclined ramp surfaces on their rear sides that are remote from bodywork opening 3, and steep abutment surfaces on their sides that are towards an inside surface 17 of the bodywork. In the fully inserted condition shown in FIGS. 3 and 4 latching noses 14 and 15 project transversely with respect to the insertion direction to such an extent that their abutment surfaces which engage behind the edge of bodywork opening 3 ensure that first housing portion 8 cannot be readily pulled out of bodywork opening 3 towards the right again.

Latching noses 14 and 15 are disposed at the front free end of tongues 16 and 16a which are formed by incisions in the outside wall of first housing portion 8. Upon insertion of first housing portion 8 into the bodywork opening 3, when the inclined ramp surfaces of the latching noses 14 and 15 pass over the edge of bodywork opening 3, tongues 16 and 16a are deflected resiliently inwardly to such an extent that the latching noses 14 and 15 can pass readily through bodywork opening 3.

The distances of the steep abutment surfaces of latching noses 14 and 15 from the rear side, which faces theretowards, of abutment 12 formed by the peripherally extending flange or collar, are completely non-critical and only have to be somewhat larger than the thickness of the sheet metal of the bodywork in the region of bodywork opening 3 so that latching noses 14 and 15 can readily resiliently engage behind inside surface 17 of the bodywork when first housing portion 8 is pushed into bodywork opening 3 to such an extent that the abutment 12 comes to bear against outside surface 13 of the bodywork. As will be described in greater detail hereinafter, the rear side of abutment 12 on the one hand and the steep abutment surfaces of latching noses 14 and 15 on the other hand come to bear against the surface of the sheet metal of the bodywork, which respectively faces theretowards, in various phases which occur in temporal succession in the assembly procedure, but never at the same time.

In the embodiment shown in FIGS. 1 through 4, first housing portion 8 carries a circuit board 18 on which is mounted a plurality of light emitting diodes 20 forming the light sources of vehicle lamp 5 according to the invention. Circuit board 18 can be in the form of a printed circuit board which is provided on one or both flat sides thereof with conductor tracks which provide for the power supply to light emitting diodes 20.

Furthermore, first housing portion 8 is integrally connected to elements 21 which have an optical function and which, in the embodiment shown, have Fresnel lenses which parallelize the light coming from corresponding light emitting diodes 20 in such a way that it issues from vehicle lamp 5, without substantial losses.

It is also possible to provide reflectors which partially embrace the light sources and may be integrally connected to first housing portion 8. Instead of light emitting diodes 20 it is also possible to use incandescent lamps as the light sources.

As can be seen from FIGS. 1 through 4, second housing portion 10 is also in the form of a hollow body. Its external contour and its external dimensions are so matched to the internal contour and the internal dimensions of first housing portion 8 that it can be slidingly and guidedly displaced therein in parallel relationship with the insertion direction.

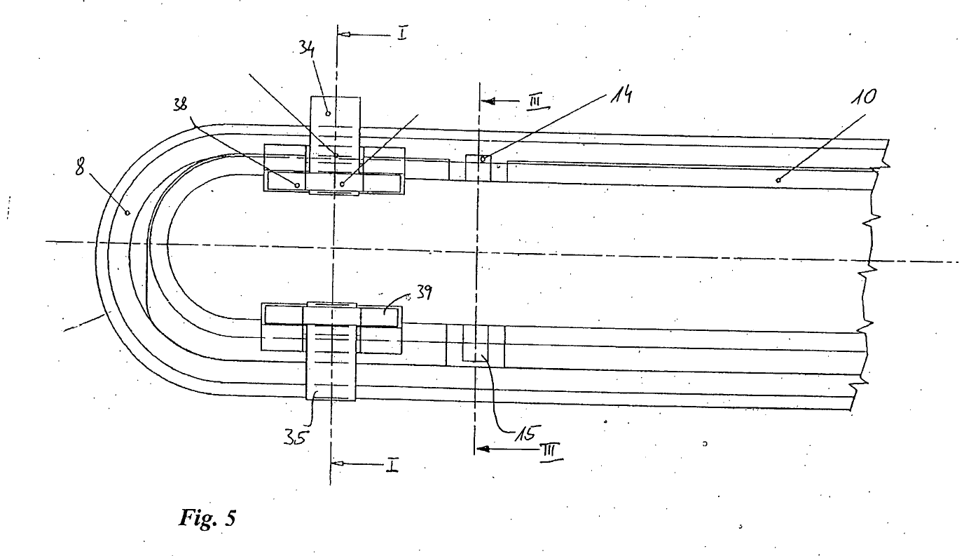

As can be seen from FIGS. 3 through 5, the axial length of second housing portion 10, extending in the insertion direction, over the major part of the width of vehicle lamp 5 which extends perpendicularly to the plane of the drawing in FIGS. 3 and 4, is of such a magnitude that the outside wall of second housing portion 10 blocks latching noses 14 and 15 in the fully inserted condition shown in FIG. 4, so that they cannot come out of engagement with inside surface 17 of the bodywork. When vehicle lamp 5 is inserted into bodywork opening 3, the above-described blocking effect does not occur as shown in FIG. 3, second housing portion 10, in the pre-assembly condition shown therein, is displaced towards the right with respect to first housing portion 8 to such an extent that its end is still outside bodywork opening 3.

In order for two housing portions 8 and 10 to be joined to form a unit in the pre-assembly condition, second housing portion 10 has two respective extension arms 25 and 26 which are arranged in mutually diametrally opposite relationship with respect to longitudinal axis 23 of the housing. In the insertion direction, extension arms 25 and 26 extend beyond the end of the hollow body forming second housing portion 10, thereby extending its external contour. Extension arms 25 and 26 bear against the inside wall of first housing portion 8 and ensure a guidance action for the above-mentioned mutual displacement of housing portions 8 and 10. In the region of extension arms 25 and 26, first housing portion 8 does not include latching noses which engage behind the sheet metal of the vehicle bodywork.

In the embodiment shown in FIGS. 1 and 2, the extension arms 25 and 26 each have respective latching nose 28 and 29 for engaging corresponding openings 30 and 31 in the wall of first housing portion 8. In this respect, the surfaces of latching noses 28 and 29, are so steep that they cannot pass over the wall surfaces, which are in opposite relationship thereto, of openings 30 and 31. Therefore second housing portion 10 cannot be further withdrawn from first housing portion 8.

Adjoining openings 30 and 31 in the insertion direction (i.e. towards the left in FIGS. 1 and 2) are passages 32 and 33 which are formed in the inside wall of first housing portion 8. The height of passages 32 and 33 is of such a magnitude that latching noses 28 and 29 can readily slide towards the left therein when second housing portion 10 is displaced out of the pre-assembly position shown in FIG. 1 and FIG. 3 into the final assembly position shown in FIG. 2 and FIG. 4.

Two shape springs 34 and 35 which are Ω-shaped in the embodiment shown in FIGS. 1 and 2, are pivotably mounted to the end of first housing portion 8 and the corresponding ends of extension arms 25 and 26, in such a way that, upon insertion of second housing portion 10 into first housing portion 8, springs 34 and 35 can be pivoted out of the position shown in FIG. 1 about pivotal mounting points 37 and 38 and 39 and 40, respectively, into the position shown in FIG. 2.

The position of pivotal mounting points 37 and 40 on first housing portion 8 with respect to pivotal mounting points 38 and 39 on second housing portion 10 is such that shape springs 34 and 35, in the pre-assembly position shown in FIG. 1, exert a force which displaces second housing portion 10 towards the right with respect to first housing portion 8 to such an extent that latching noses 28 and 29 come to bear with their steep end faces against the right-hand inside surfaces of openings 30 and 31.

If a force acting in the insertion direction is applied to second housing portion 10 after insertion of vehicle lamp 5 into bodywork opening 3, shape springs 34 and 35 transmit that force to first housing portion 8. Abutment 12 of first housing portion 8 bears against outside surface 13 of the bodywork and, therefore, first housing portion 8 cannot slide more deeply into bodywork opening 3. In the course of the movement, further stressing of the shape springs 34 and 35 takes place until a dead point position is reached. After springs 34 and 35 move beyond that position, they pivot further about pivotal mounting points 37, 38 and 39, 40 until they have reached the position shown in FIG. 2 wherein shape springs 34 and 35 apply a force to second housing portion 10 in the insertion direction with respect to first housing portion 8. A reaction force is exerted on first housing portion in the opposite direction and is carried by latching noses 14 and 15, which are supported against inside surface 17 of the bodywork.

The above-described embodiment provides a bistable spring arrangement that pivots from a pre-assembly position into a final assembly position and reverses the direction of the force exerted thereby between housing portions 8 and 10.

As shown in FIGS. 1 through 4 an outer side, of second housing portion 10 has a flange 42 which projects transversely with respect to the insertion direction and which carries a sealing ring 44 on its side that faces towards outside surface 13 of the bodywork. As shown in FIGS. 2 and 4, sealing ring 44 is pressed against outside surface 17 of the vehicle bodywork in a moisture-tight manner by the force of shape springs 34 and 35, in the final assembly condition. The end of the hollow body formed by second housing portion 10 is sealingly closed by a light transmission cover 46, which can be provided in one piece with the second housing portion 10. Therefore a moisture-tight closure for the bodywork opening 3 is provided.

In order to ensure that the pressing effect of sealing ring 44 is always uniform, the spacing of flange 42 from outside surface 13 of the vehicle bodywork can be kept constant by way of additional spacer elements 48 provided at the outer ends of flange 42, spacer elements 48 bear against outside surface 13 of the vehicle bodywork in the final assembly condition.

Removal of vehicle lamp 5 can be effected by withdrawing second housing portion 10, against the force of springs 34 and 35, with a special tool which engages into suitable apertures in second housing portion 10. Thereafter latching noses 14 and 15 on first housing portion 8 are accessible for disengagement. Vehicle lamp 5 can then be drawn out of bodywork opening 3.

Instead of Ω-shaped springs 34 and 35 it is also possible to use wire loop springs, shape springs having a U-shaped configuration, torsion springs, compression springs, etc. By virtue of arranging an elongate shape spring with two outer pivotal mounting points on one housing portion and a central pivotal mounting point on the other housing portion, the desired function can also be performed with a reduced number of springs.

It will be appreciated that the above-described embodiments have been set forth solely by way of illustration and example and that various alterations and modifications may be made without departing from the spirit and scope of the invention.

What is claimed is:

1. A vehicle lamp for insertion into a vehicle bodywork opening comprising
a lamp housing including an abutment adapted when the lamp housing is introduced from an exterior into the bodywork opening, to come to bear against a part of the vehicle,
a sealing means which, in an installed condition of the lamp housing, sealingly closes the bodywork opening;
at least one latching means adapted, in said installed condition, to engage behind an edge of the bodywork opening and operable to prevent the vehicle lamp from moving out of the bodywork opening;
wherein the lamp housing includes first and second housing portions of which the first housing portion has an abutment and the at least one latching means and the sealing means is on the second housing portion;
means for mounting the first and second housing portions displaceably relative to each other in an installation direction from a pre-assembly position into a final assembly position, and
a bistable spring arrangement on the first and second housing portions and operable in the pre-assembly position to urge the first and second housing portions away from each other in opposite relationship to the installation direction and in the final assembly position to pull them towards each other in the installation direction whereby the sealing means is pressed from the exterior against outside surface of the vehicle bodywork.

2. A vehicle lamp as set forth in claim 1
wherein the first housing portion is substantially in the form of a hollow body which is open at least an end that faces outwardly in the installed position and in an interior of which the second housing portion is displaceably mounted.

3. A vehicle lamp as set forth in claim 1 including
a further latching means defining the pre-assembly position and fixed in opposite relationship to the installation direction and unlatchable in the installation direction by an assembly force which is applied from the exterior and which overcomes the biasing force of a bistable spring arrangement.

4. A vehicle lamp as set forth in claim 1
wherein the abutment comprises a flange which is provided at an end facing outwardly in the installed position of the first housing portion and which in said installed condition bears from the outside against said outside surface of the bodywork.

5. A vehicle lamp as set forth in claim 1
wherein the abutment is formed by a region of the first housing portion, said region, in the installed condition of the lamp. coming to bear against a fixed part of the vehicle behind the bodywork opening.

6. A vehicle lamp as set forth in claim 1
wherein the first housing portion carries elements of the vehicle lamp, which have an optical function.

7. A vehicle lamp as set forth in claim 6
wherein the elements having an optical function are provided integrally with the first housing portion.

8. A vehicle lamp as set forth in claim 1
wherein the first housing portion carries elements of the vehicle lamp, which have a light-technical function.

9. A vehicle lamp as set forth in claim 1
wherein the second housing portion carries a light transmission cover.

10. A vehicle lamp as set forth in claim 9
wherein the second housing portion and the light transmission cover are integrally connected together.

11. A vehicle lamp as set forth in claim 8
wherein the abutment comprises a peripherally extending flange and the second housing portion has a flange which projects laterally beyond the peripherally extending flange of the first housing portion and the sealing means is so arranged behind the flange of the second housing portion such that in the installed condition of the lamp housing the flange of the second housing portion is pressed against the outside surface of the vehicle bodywork outside the peripherally extending flange of the first housing portion.
